(19) United States
(12) Patent Application Publication
(10) Pub. No.: US 2020/0136139 A1
(43) Pub. Date: Apr. 30, 2020

(54) ALKALINE SECONDARY BATTERY

(71) Applicants: Toyota Jidosha Kabushiki Kaisha, Toyota-shi Aichi-ken (JP); Hiroshima University, Higashi-Hiroshima-shi (JP)

(72) Inventors: Haruyuki Nakanishi, Nagoya-shi (JP); Yoshitsugu Kojima, Higashi-Hiroshima-shi (JP)

(21) Appl. No.: 16/659,880

(22) Filed: Oct. 22, 2019

(30) Foreign Application Priority Data
Oct. 24, 2018 (JP) 2018-199923

(51) Int. Cl. H01M 4/50; H01M 10/30; H01M 4/52

(52) U.S. Cl. CPC H01M 4/502; H01M 4/52; H01M 10/30

(57) ABSTRACT

An alkaline secondary battery includes at least a case, a positive electrode, a negative electrode, and an electrolyte solution. The case accommodates the positive electrode, the negative electrode, and the electrolyte solution. The positive electrode includes manganese dioxide and nickel hydroxide. The negative electrode includes a hydrogen storage alloy.

### CROSS REFERENCE TO RELATED APPLICATIONS

This nonprovisional application claims priority to Japanese Patent Application No. 2018499923 filed on Oct. 24, 2018, with the Japan Patent Office, the entire contents of which are hereby incorporated by reference.

### BACKGROUND

### Field

The present disclosure relates to an alkaline secondary battery.

### Description of the Background Art

Japanese Patent Laying-Open No. 2-223150 discloses an alkaline rechargeable battery (an alkaline secondary battery) that includes manganese dioxide as a main constituent of a positive electrode and a hydrogen storage alloy as a main constituent of a negative electrode.

### SUMMARY

Nickel-metal hydride (Ni-MH) batteries have been in practical use.

A Ni-MH battery is an alkaline secondary battery. A Ni-MH battery includes nickel hydroxide [Ni(OH)₂] as a positive electrode active material and a hydrogen storage alloy as a negative electrode active material. Nickel is relatively expensive and its price tends to fluctuate greatly. Therefore, an inexpensive positive electrode active material has been demanded to replace nickel hydroxide.

Japanese Patent Laying-Open No. 2-223150 discloses use of manganese dioxide (MnO₂) as a positive electrode active material. Manganese dioxide is used as a positive electrode active material of an alkaline manganese dry battery, for example. Manganese dioxide may be less expensive than nickel hydroxide.

However, manganese dioxide does not contain hydrogen. Nor does the hydrogen storage alloy, at the time of battery assembly. Charge carriers in an alkaline secondary battery are hydrogen ions. When neither a positive electrode active material nor a negative electrode active material contains hydrogen, the positive electrode active material (manganese dioxide) is not capable of performing charge and discharge in theory.

An object of the present disclosure is to provide an alkaline secondary battery that includes manganese dioxide in a positive electrode and a hydrogen storage alloy in a negative electrode.

In the following, the technical structure and the effects according to the present disclosure are described. It should be noted that the action mechanism according to the present disclosure includes presumption. Therefore, the scope of claims should not be limited by Whether or not the action mechanism is correct.

[1] An alkaline secondary battery according to the present disclosure includes at least a case, a positive electrode, a negative electrode, and an electrolyte solution. The case accommodates the positive electrode, the negative electrode, and the electrolyte solution. The positive electrode includes manganese dioxide and nickel hydroxide. The negative electrode includes a hydrogen storage alloy.

The positive electrode of the alkaline secondary battery according to the present disclosure includes both manganese dioxide and nickel hydroxide. Partially replacing nickel hydroxide with manganese dioxide in this way may reduce the material cost. Although the detailed mechanism is unclear, manganese dioxide in the presence of nickel hydroxide may be capable of performing charge and discharge. In addition, the alkaline secondary battery according to the present disclosure may have substantially the same performance (charge-discharge capacity, voltage) as a conventional Ni-MH battery.

[2] The alkaline secondary battery according to the present disclosure may further have a configuration described below.

The hydrogen storage alloy has an equilibrium dissociation pressure of 0.2 MPa or higher. The case is filled with hydrogen gas. The hydrogen gas has a pressure equal to or higher than the equilibrium dissociation pressure of the hydrogen storage alloy.

In a conventional Ni-MH battery, a hydrogen storage alloy has an equilibrium dissociation pressure of 0.1 MPa or lower. The “equilibrium dissociation pressure” refers to a pressure at which the hydrogen storage alloy is capable of reversibly storing and releasing hydrogen. In the present specification, a hydrogen storage alloy having an equilibrium dissociation pressure of 0.1 MPa or lower is also called “low-dissociation-pressure alloy” and a hydrogen storage alloy having an equilibrium dissociation pressure of 0.2 MPa or higher is also called “high-dissociation-pressure alloy”.

The hydrogen storage capacity of the high-dissociation-pressure alloy tends to be higher than the hydrogen storage capacity of the low-dissociation-pressure alloy. Therefore, using the high-dissociation-pressure alloy may increase negative electrode capacity and thereby may increase battery capacity. Moreover, using the high-dissociation-pressure alloy tends to increase discharge voltage. This phenomenon may be explained by Nernst's equation, for example. Using the high-dissociation-pressure alloy may also improve output.

The high-dissociation-pressure alloy cannot stably store and release hydrogen unless the high-dissociation-pressure alloy is under a pressure equal to or higher than its equilibrium dissociation pressure. Considering this, the case according to the configuration of [2] above is filled with hydrogen gas. The hydrogen gas has a pressure equal to or higher than the equilibrium dissociation pressure. In this configuration, the high-dissociation-pressure alloy may be capable of stably storing and releasing hydrogen.

The hydrogen gas with which the case is filled may also function as a negative electrode active material. More specifically, electrical energy may be obtained from dissociation reaction of the hydrogen gas. The principle of this is similar to the principle of operation of a negative electrode of a nickel-hydrogen gas (Ni—H₂) battery, for example. As a result of the hydrogen gas functioning as a negative electrode active material, negative electrode capacity may increase.

Under normal circumstances, gas has a great volume. In contrast, the hydrogen gas according to [2] above is in a compressed state with a pressure of 0.2 MPa or higher. As a result, the alkaline secondary battery having the configuration of [2] above may have a high volumetric energy density (energy per unit volume).

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view illustrating an example configuration of the alkaline secondary battery according to the present embodiment.

FIG. 2 is an example of a hydrogen pressure-composition-temperature curve (PCT curve) for an AB₅ alloy.

FIG. 3 is an example of a PCT curve for an A₅B₁₉ alloy.

FIG. 4 illustrates results of charge and discharge in Example 2.

FIG. 5 illustrates results of charge and discharge in Comparative Example 24.

### DETAILED DESCRIPTION

In the following, embodiments according to the present disclosure (herein called “present embodiment”) are described. However, the description below does not limit the scope of claims.

### Alkaline Secondary Battery

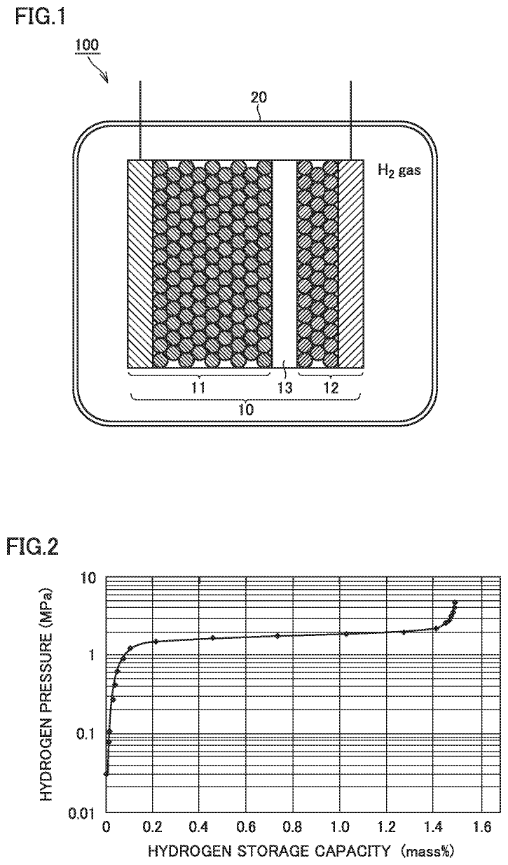

FIG. 1 is a schematic view illustrating an example configuration of an alkaline secondary battery according to the present embodiment.

A battery 100 is an alkaline secondary battery. Battery 100 includes at least a case 20, an electrode group 10, and an electrolyte solution (not illustrated). The shape of case 20 is not particularly limited. The shape of case 20 may be cylindrical, prismatic, or coin-like, for example.

Case 20 may be filled with hydrogen gas. In this configuration, the structure of case 20 is capable of withstanding the pressure of the hydrogen gas. For instance, case 20 may be a pressure vessel for high-pressure hydrogen gas.

Electrode group 10 includes a positive electrode 11, a negative electrode 12, and a separator 13. In other words, battery 100 includes at least case 20, positive electrode 11, negative electrode 12, and the electrolyte solution. For instance, electrode group 10 may be a wound-type one. More specifically, electrode group 10 may be formed by stacking positive electrode 11, separator 13, and negative electrode 12 in this order and then winding them in a spiral manner. For instance, electrode group 10 may be a stack-type one. More specifically, electrode group 10 may be formed by alternately stacking one positive electrode 11 and one negative electrode 12 and then repeating this alternate stacking process more than once. In each space between positive electrode 11 and negative electrode 12, separator 13 is interposed.

### Positive Electrode

Positive electrode 11 may be in plate-like form or in sheet form, for example. Positive electrode 11 may have a thickness ranging from 10 μm to 1 mm, for example. Positive electrode 11 includes at least a positive electrode active material. The positive electrode active material may be in the form of particles (powder), for example. The D50 of the positive electrode active material may range from 1 μm to 30 μm, for example. The “D50” refers to a particle size in volume-based particle size distribution at which the cumulative particle volume (accumulated from the side of small sizes) reaches 50% of the total particle volume.

(Manganese dioxide and Nickel Hydroxide)

The positive electrode active material according to the present embodiment is a combination of manganese dioxide and nickel hydroxide. In other words, positive electrode 11 includes manganese dioxide and nickel hydroxide. Because positive electrode 11 thus includes both manganese dioxide and nickel hydroxide, manganese dioxide may function as a positive electrode active material. The manganese dioxide may have various crystal structures. The manganese dioxide may be a β-type manganese dioxide, for example. The nickel hydroxide may also have various crystal structures. The nickel hydroxide may be a β-type nickel hydroxide, for example.

For instance, positive electrode 11 may have a multilayer structure. For instance, the multilayer structure may be a stack of a first layer containing manganese dioxide and a second layer containing nickel hydroxide. For instance, the manganese dioxide and the nickel hydroxide may form composite particles. For instance, a surface of the nickel hydroxide may be covered with the manganese dioxide.

The mass ratio between manganese dioxide and nickel hydroxide in positive electrode 11 may be “(manganese dioxide):(nickel hydroxide)=40:60 to 60:40”, for example. The mass ratio between manganese dioxide and nickel hydroxide may be “(manganese dioxide):(nickel hydroxide)=50:50”, for example.

(Other Structural Details)

Positive electrode 11 may consist essentially of the positive electrode active material. Positive electrode 11 may further include a current collector, a conductive material, a binder, and the like in addition to the positive electrode active material.

The current collector is not particularly limited. The current collector may be a porous metal, a perforated metal plate, and/or the like. Positive electrode 11 may be produced by, for example, filling a pore of a porous metal with the positive electrode active material and the like. The porous metal may be a porous nickel sheet and/or the like. The current collector may be “Celmet (registered trademark)” manufactured by Sumitomo Electric Industries, Ltd., for example.

The conductive material is not particularly limited. The conductive material may be cobalt hydroxide [Co(OH)₂], cobalt oxide (CoO), and/or the like. The content of the conductive material may range, for example, from 0.1 parts by mass to 20 parts by mass relative to, for example, 100 parts by mass of the positive electrode active material.

The binder is not particularly limited. The binder may be carboxymethylcellulose (CMC), polyacrylic acid (PAA), polyvinyl alcohol (PVA), polytetrafluoroethylene (PTFE), polyacrylonitrile (PAN), styrene-butadiene rubber (SBR), and/or the like. The content of the binder may range, for example, from 0.1 parts by mass to 20 parts by mass relative to 100 parts by mass of the positive electrode active material.

### Negative Electrode

Negative electrode 12 may be in plate-like form or in sheet form, for example. Negative electrode 12 may have a thickness ranging from 10 μm to 1 mm, for example. Negative electrode 12 includes at least a negative electrode active material. The negative electrode active material may be in the form of particles. The D50 of the negative electrode active material may range from 1 μm to 30 μm, for example.

(Hydrogen Storage Alloy)

The negative electrode active material according to the present embodiment is a hydrogen storage alloy. In other words, negative electrode 12 includes a hydrogen storage alloy. The hydrogen storage alloy reversibly stores and releases hydrogen. The hydrogen storage alloy is not particularly limited. The hydrogen storage alloy may be an AB alloy (such as TiFe), an AB₂ alloy (such as ZrMn₂, ZrV₂, and/or ZrNi₂), an A₂B alloy (such as Mg₂Ni and/or Mg₂Cu), an ABs alloy (such as CaNi₅, LaNi₅, and/or MmNi₅), an A₂B₇ alloy (such as La₂Ni₇), and/or an A₅B₁₉ alloy (such as Pr₄MgNi₁₉), for example. Negative electrode 12 may include only one type of the hydrogen storage alloy. Negative electrode 12 may include two or more types of the hydrogen storage alloy. For instance, negative electrode 12 may include at least one selected from the group consisting of an ABs alloy, an A₂B₇ alloy, and an A₅B₁₉ alloy.

The “Mm” in “MmNi₅” and/or the like represents a misch metal. A misch metal is a mixture of rare earth elements and mainly consists of Ce and La. The expression “mainly consists of Ce and La” means that a combination of Ce and La accounts for 50 mass % or more of the mixture. The Mm may include Nd, Pr, Sm, Mg, Al, Fe, and the like in addition to Ce and La. For instance, the Mm may include Ce in an amount from 40 mass % to 60 mass % and La in an amount from 10 mass % to 35 mass % with the remainder being made up of Nd, Pr, Sm, and/or the like. For instance, the Mm may include 53.7 mass % Ce, 24.1 mass % La, 16.5 mass % Nd, and 5.8 mass % Pr.

(Equilibrium Dissociation Pressure)

The hydrogen storage alloy has an equilibrium dissociation pressure. For instance, the equilibrium dissociation pressure of the hydrogen storage alloy may range from 0.01 MPa to 10 MPa. For instance, the equilibrium dissociation pressure of the hydrogen storage alloy may be 0.1 MPa or lower. In other words, the hydrogen storage alloy may be a low-dissociation-pressure alloy. The low-dissociation-pressure alloy may be MmNi_{4.14}Co_{0.29}Mn_{0.49}Al_{0.30} (equilibrium dissociation pressure, 0.01 MPa), for example.

For instance, the equilibrium dissociation pressure of the hydrogen storage alloy may be 0.2 MPa or higher . In other words, the hydrogen storage alloy may be a high-dissociation-pressure alloy. The hydrogen storage capacity of the high-dissociation-pressure alloy tends to be higher than the hydrogen storage capacity of the low-dissociation-pressure alloy. Using the high-dissociation-pressure alloy as the hydrogen storage alloy may increase negative electrode capacity. Moreover, using the high-dissociation-pressure alloy tends to increase discharge voltage. Furthermore, using the high-dissociation-pressure alloy as the hydrogen storage alloy may improve output. For instance, the equilibrium dissociation pressure of the hydrogen storage alloy may be 2 MPa or higher. For instance, the equilibrium dissociation pressure of the hydrogen storage alloy may range from 0.2 MPa to 2 MPa.

The high-dissociation-pressure alloy may be Pr₄MgNi₁₉ (equilibrium dissociation pressure, 0.2 MPa), MmNi_{4.7}Fe_{0.3} (equilibrium dissociation pressure, 1.6 MPa), MmNi_{4.5}Cr_{0.5} (equilibrium dissociation pressure, 0.57 MPa), MmNi_{4.5}Mn_{0.5} (equilibrium dissociation pressure, 0.33 MPa), MmNi_{4.5}Al_{0.5} (equilibrium dissociation pressure, 0.38 MPa), MmNi_{4.5}Cr_{0.45}Mn_{0.05} (equilibrium dissociation pressure, 0.30 MPa), MmNi_{4.5}Cr_{0.25}Mn_{0≡}(equilibrium dissociation pressure, 0.2 MPa), MmNi₅ (equilibrium dissociation pressure, 2.3 MPa), MmNi_{4.2}Co_{0.8} (equilibrium dissociation pressure, 2.1 MPa), and/or MmNi_{4.12}Co_{0.79} (equilibrium dissociation pressure, 2 MPa), for example. The high-dissociation-pressure alloy may be at least one selected from the group consisting of Pr₄MgNi₁₉ and MmNi_{4.12}Co_{0.79,} for example.

(Measurement Method)

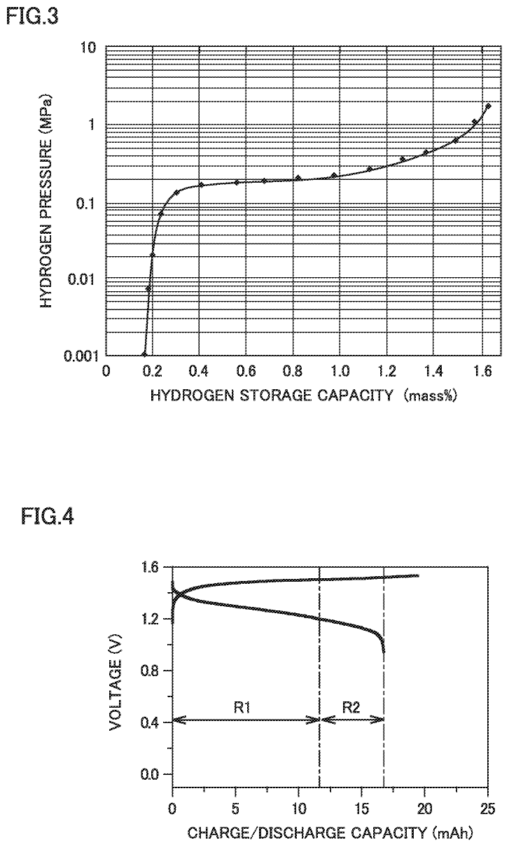

FIG. 2 is an example of a hydrogen pressure-composition-temperature curve (PCT curve) for an AB₅ alloy. FIG. 3 is an example of a PCT curve for an A₅B₁₉ alloy. Each of the PCT curves in FIGS. 2 and 3 is for high-dissociation-pressure alloy. The AB₅ alloy in FIG. 2 has an equilibrium dissociation pressure of about 2 MPa. The A₅B₁₉ alloy in FIG. 3 has an equilibrium dissociation pressure of about 0.2 MPa.

The “equilibrium dissociation pressure” herein refers to a value measured at 23° C. The equilibrium dissociation pressure is obtained from the PCT curve. The PCT curve is obtained by using Sieverts' method. Each value for forming the release line of the PCT curve is obtained by measurement in accordance with “JIS II 7201”. For the measurement, a conventionally known Sieverts' instrument may be used. In the room (a thermostatic chamber) where the measurement takes place, a thermometer is placed. When the measurement is carried out with the thermometer indicating “23° C.±1° C.”, the resulting release line is regarded as obtained at 23° C.

In the PCT curve (FIGS. 2 and 3), the ordinate represents hydrogen pressure. The ordinate is based on a common logarithmic scale. The abscissa represents hydrogen storage capacity. At least ten points derived from the measurement are connected to form the release line. Desirably, 20 points derived from the measurement are connected to form the release line.

For each combination of three adjacent points on the release line, the points are connected into a straight line. The slope of the straight line is calculated. When the three adjacent points do not sit on a single straight line, a least square method is used to obtain the straight line slope. A combination of three adjacent points having the smallest slope is selected. The arithmetic mean of the hydrogen pressures for these three adjacent points is used as the “equilibrium dissociation pressure” according to the present specification.

(Other Structural Details)

Negative electrode 12 may consist essentially of the negative electrode active material. Negative electrode 12 may further include a current collector, a conductive material, a binder, and the like in addition to the negative electrode active material.

The current collector is not particularly limited. For instance, the current collector may be a material described above as an example of the current collector of positive electrode 11. Negative electrode 12 may be produced by, for example, filling a pore of a porous metal with the negative electrode active material and the like.

The conductive material is not particularly limited. The conductive material may be carbon black and/or the like. The content of the conductive material may range, for example, from 0.1 parts by mass to 20 parts by mass relative to 100 parts by mass of the negative electrode active material. The binder is not particularly limited. The binder may be a material described above as an example of the binder of positive electrode 11. The content of the binder may range, for example, from 0.1 parts by mass to 20 parts by mass relative to 100 parts by mass of the negative electrode active material.

### Hydrogen Gas

Case 20 may be filled with hydrogen gas. The hydrogen gas may have a pressure equal to or higher than the equilibrium dissociation pressure of the hydrogen. storage alloy. In this configuration, the hydrogen storage alloy (high-dissociation-pressure alloy, in particular) may be capable of stably storing and releasing hydrogen.

The hydrogen gas with which case 20 is filled may also function as a negative electrode active material. As a result of the hydrogen gas functioning as a negative electrode active material, negative electrode capacity may increase. The higher the pressure of the hydrogen gas is (namely, the stronger the force compressing the hydrogen gas is), the higher the volumetric energy density may be.

The pressure of the hydrogen gas may be 0.015 MPa or higher, for example. The pressure of the hydrogen gas may be 0.2 MPa or higher, for example. The pressure of the hydrogen gas may be 0.3 MPa or higher, for example. The pressure of the hydrogen gas may be 2 MPa or higher, for example. The pressure of the hydrogen gas may be 3 MPa or higher, for example. The pressure of the hydrogen gas may be 10 MPa or higher, for example. It should be noted that the higher the pressure of the hydrogen gas is, the higher the strength and other properties of case 20 need to be. The pressure of the hydrogen gas may be not higher than 20 MPa, for example.

### Separator

Separator 13 is porous. Separator 13 may have a thickness ranging from 10 μm to 1 mm, for example. Separator 13 is electrically insulating. For instance, separator 13 may be a nonwoven polyolefin fabric. For instance, separator 13 may be a microporous polyolefin film.

### Electrolyte Solution

The electrolyte solution is an aqueous alkali solution. The electrolyte solution may be an aqueous solution of potassium hydroxide (KOH), an aqueous solution of lithium hydroxide (LiOH), and/or an aqueous solution of sodium hydroxide (NaOH), for example. The aqueous alkali solution may contain at least one selected from the group consisting of KOH, LiOH, and NaOH dissolved therein. The concentration of the aqueous alkali solution may range from 1 mol//L to 10 mol//L, for example.

### EXAMPLES

In the following, examples according to the present disclosure (herein called “present example”) are described. However, the description below does not limit the scope of claims.

### Production of Alkaline Secondary Battery

Various batteries 100 (alkaline secondary batteries) were produced as described below. The design charged capacity of battery 100 of the present example ranged from 20 to 21 mAh.

### Example 1

A first electrode was prepared. The first electrode was in disc form. The first electrode had a diameter of 10 mm. The first electrode included β-MnO₂ (with a stoichiometric capacity of 308 mAh/g and a standard electric potential of 0.15 V) as a positive electrode active material.

A second electrode was prepared. The second electrode was in disc than. The second electrode had a diameter of 10 mm. The second electrode included β-Ni(OH)₂ (with a stoichiometric capacity of 289 mAh/g and a standard electric potential of 0.52 V) as a positive electrode active material.

The first electrode and the second electrode were stacked on top of one another, and thereby positive electrode 11 was prepared. Positive electrode 11 was in disc form. Positive electrode 11 had a diameter of 10 mm. The mass ratio between the first electrode and the second electrode was 50:50. hit other words, the mass ratio between β-MnO₂ and β-Ni(OH)₂ in positive electrode 11 was “β-MnO₂:β-Ni(OH)₂=50:50”.

Negative electrode 12 was prepared. Negative electrode 12 was in disc form. Negative electrode 12 had a diameter of 10 mm. Negative electrode 12 included MmNi_{4.14}Co_{0.29}Mn_{0.49}Al_{0.30} (equilibrium dissociation pressure, 0.01 MPa) as a negative electrode active material.

Separator 13 was prepared. Separator 13 was a nonwoven fabric made of polyolefin resin fibers. Separator 13 had a thickness of 0.15 mm. Separator 13, positive electrode 11, and negative electrode 12 were stacked in such a manner that positive electrode 11 and negative electrode 12 faced each other with separator 13 interposed therebetween. In this way, electrode group 10 was formed.

Case 20 was prepared. In case 20, electrode group 10 was placed. The pressure of hydrogen gas in case 20 was 0.015 MPa. Into case 20, a predetermined amount of an electrolyte solution was injected. The electrolyte solution was an aqueous solution of potassium hydroxide (concentration, 6 mol//L). In this way, battery 100 of Example 1 was produced.

### Comparative Example 1-1

A positive electrode was prepared. The positive electrode was in disc form.

The positive electrode had a diameter of 10 mm. The positive electrode included β-Ni(OH)₂ as a positive electrode active material. The design charged capacity of the positive electrode was 20 mAh. Except the use of this positive electrode, the same manner as in Example 1 was adopted to produce battery 100.

### Comparative Example 1-2

A positive electrode was prepared. The positive electrode was in disc form. The positive electrode had a diameter of 10 mm. The positive electrode included β-MnO₂ as a positive electrode active material. Except the use of this positive

### Example 2

Positive electrode 11 was prepared in the same manner as in Example 1. Negative electrode 12 was prepared. Negative electrode 12 of Example 2 included MmNi_{4.12}Co_{0.79} (equilibrium dissociation pressure, 2 MPa) as a negative electrode active material. Electrode group 10 was formed in the same manner as in Example 1. Electrode group 10 was placed in case 20. In Example 2, case 20 was filled with hydrogen gas. The pressure of hydrogen gas in case 20 was 3 MPa. Into case 20, a predetermined amount of an electrolyte solution was injected. The electrolyte solution was an aqueous solution of potassium hydroxide (concentration, 6 mol/L), In

### Comparative Example 2-1

A positive electrode was prepared. The positive electrode was in disc form. The positive electrode had a diameter of 10 mm. The positive electrode included β-Ni(OH)₂ as a positive electrode active material. Except the use of this positive electrode, the same manner as in Example 2 was adopted to produce battery 100.

### Comparative Example 2-2

A positive electrode was prepared. The positive electrode was in disc form. The positive electrode had a diameter of 10 mm. The positive electrode included β-MnO₂ as a positive electrode active material. Except the use of this positive

### Example 3

Positive electrode 11 was prepared in the same manner as in Example 1. Negative electrode 12 was prepared. Negative electrode 12 of Example 3 included Pr₄MgNi₁₉ (equilibrium dissociation pressure, 0.2 MPa) as a negative electrode active material. Pr₄MgNi₁₉ was a cobalt-free A₅B₁₉ alloy. Electrode group 10 was formed in the same manner as in Example 1. Electrode group 10 was placed in case 20. In Example 2, case 20 was filled with hydrogen gas. The pressure of hydrogen gas in case 20 was 0.3 MPa. Into case 20, a predetermined amount of an electrolyte solution was injected. The electrolyte solution was an aqueous solution of potassium hydroxide (concentration, 6 mol/L). In this way, battery 100 of Example 3 was produced.

### Charge-Discharge Test

At a rate of 0.08 C, charge and discharge of battery 100 was carried out. The “C” is the unit of rate. At a rate of 1 C, charging a battery to its design capacity completes in one hour. Table 1 below lists charged capacity, discharged capacity, average charging voltage, maximum charging voltage, average discharging voltage, discharge cut-off voltage, and average voltage.

The average charging voltage refers to a value of voltage that is read for a charged capacity of 50% on a charging curve. The average discharging voltage refers to a value of voltage that is read for a discharged capacity of 50% on a discharging curve. The average voltage is the arithmetic mean of the average charging voltage and the average discharging voltage.

TABLE 1

| | | Negative electrode | | | |
|---|---|---|---|---|---|
| | | Hydrogen | | | |
| | | storage alloy | | | Charge-discharge |
| | | | Equilibrium | | test |
| | | | dissociation | Hydrogen | Charged |
| | | | pressure | gas | capacity |
| | Positive electrode | Composition | [MPa] | [MPa] | [mAh] |
| Ex. 1 | MnO₂:Ni(OH)₂=50:50 | MmNi_{4.14}Co_{0.29}Mn_{0.49}Al_{0.30} | 0.01 | 0.015 | 21 |
| Comp. | Ni(OH)₂ | MmNi_{4.14}Co_{0.29}Mn_{0.49}Al_{0.30} | 0.01 | 0.015 | 20 |
| Ex. 1-1 | | | | | |
| Comp. | MnO₂ | MmNi_{4.14}Co_{0.29}Mn_{0.49}Al_{0.30} | 0.01 | 0.015 | No |
| Ex. 1-2 | | | | | charge |
| | | | | | occurred |
| Ex. 2 | MnO₂:Ni(OH)₂=50:50 | MmNi_{4.12}Co_{0.79} | 2 | 3 | 21 |
| Comp. | Ni(OH)₂ | MmNi_{4.12}Co_{0.79} | 2 | 3 | 20 |
| Ex. 2-1 | | | | | |
| Comp. | MnO₂ | MmNi_{4.12}Co_{0.79} | 2 | 3 | No |
| Ex. 2-2 | | | | | charge |
| | | | | | occurred |
| Ex. 3 | MnO₂:Ni(OH)₂=50:50 | Pr₄MgNi₁₉ | 0.2 | 0.3 | 20 |

| | Charge-discharge test | | | | | |
|---|---|---|---|---|---|---|
| | | Average | Maximum | Average | Discharge | |
| | Discharged | charging | charging | discharging | cut-off | Average |
| | capacity | voltage | voltage | voltage | voltage | voltage |
| | [mAh] | [V] | [V] | [V] | [V] | [V] |
| Ex. 1 | 16.8 | 1.47 | 1.50 | 1.22 | 1 | 1.35 |
| Comp. | 17.0 | 1.48 | 1.53 | 1.26 | 1 | 1.37 |
| Ex. 1-1 | | | | | | |
| Comp. | No | — | — | — | — | — |
| Ex. 1-2 | discharge | | | | | |
| | occurred | | | | | |
| Ex. 2 | 16.7 | 1.50 | 1.52 | 1.25 | 1 | 1.38 |
| Comp. | 16.9 | 1.51 | 1.56 | 1.29 | 1 | 1.40 |
| Ex. 2-1 | | | | | | |
| Comp. | No | — | — | — | — | — |
| Ex. 2-2 | discharge | | | | | |
| | occurred | | | | | |
| Ex. 3 | 16.0 | 1.48 | 1.51 | 1.24 | 1 | 1.36 |

### Results of Experiment

In Example 1, positive electrode 11 included both manganese dioxide and nickel hydroxide. Each of the charged capacity and the discharged capacity obtained in Example 1 was substantially the same as it was designed. Therefore, manganese dioxide may have functioned as a positive electrode active material.

The configuration of Comparative Example 1-1 was the same as the configuration of a conventional Ni-MH battery. The performance obtained in Example 1 was substantially the same as the performance obtained in Comparative Example 1-1.

In Examples 2 and 3, positive electrode 11 included both manganese dioxide and nickel hydroxide. In Examples 2 and 3, as in Example 1, manganese dioxide may have functioned as a positive electrode active material.

In Examples 2 and 3, negative electrode 12 included a high-dissociation-pressure alloy and case 20 was filled with hydrogen gas. In Examples 2 and 3, the high-dissociation-pressure alloy and the hydrogen gas may have functioned as a negative electrode active material. Negative electrode 12 of Examples 2 and 3 may be regarded as a hybrid negative electrode composed of the high-dissociation-pressure alloy and the hydrogen gas. In Examples 2 and 3, the average discharging voltage was higher than in Example 1.

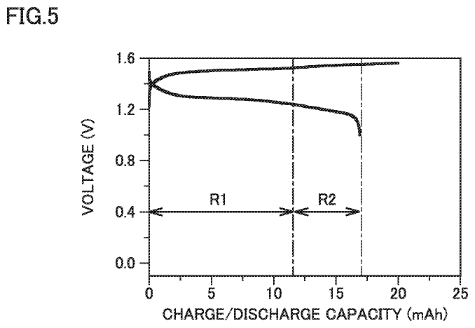

FIG. 4 illustrates results of charge and discharge in Example 2.FIG. 5 illustrates results of charge and discharge in Comparative Example 2-1.

The abscissa in FIGS. 4 and 5 represents charge-discharge capacity. The ordinate in FIGS. 4 and 5 represents voltage. As is clear from FIGS. 4 and 5, the batteries of Example 2 and Comparative Example 2-1 were capable of performing charge and discharge. The batteries of Example 2 and Comparative Example 2-1 had substantially the same performance (charge-discharge capacity, voltage).

It is considered that a first region R1 in FIGS. 4 and 5 is where the hydrogen storage alloy was mainly responsible for charge and discharge and a second region R2 in FIGS. 4 and 5 is where the hydrogen gas was mainly responsible for charge and discharge.

As is clear from Table 1 above, the batteries of Comparative Example 1-2 and Comparative Example 2-2 were incapable of performing charge and discharge. It is considered that, in Comparative Example 1-2 and Comparative Example 2-2, positive electrode 11 did not include both manganese dioxide and nickel hydroxide and thereby manganese dioxide was incapable of performing charge and discharge.

The embodiments and examples disclosed herein are illustrative and non-restrictive in any respect. The technical scope indicated by the claims encompasses any modifications within the scope and meaning equivalent to the terms of the claims.

What is claimed is:

1. An alkaline secondary battery comprising at least:
a case;
a positive electrode;
a negative electrode; and
an electrolyte solution,
the case accommodating the positive electrode, the negative electrode, and the electrolyte solution,
the positive electrode including manganese dioxide and nickel hydroxide,
the negative electrode including a hydrogen storage alloy.

2. The alkaline secondary battery according to claim 1, wherein
the hydrogen storage alloy has an equilibrium dissociation pressure of 0.2 MPa or higher,
the case is filled with hydrogen gas, and
the hydrogen gas has a pressure equal to or higher than the equilibrium dissociation pressure of the hydrogen storage alloy.
